(19) United States
(12) Patent Application Publication
(10) Pub. No.: US 2007/0052832 A1
(43) Pub. Date: Mar. 8, 2007

(54) Digital image processing apparatus and method of displaying image

(75) Inventors: Sung-cheol Bae, Seongnam-si (KR); Joo-bok Kim, Seongnam-si (KR); Won-hee Jeong, Changwon-si (KR)

Correspondence Address: GARDNER CARTON & DOUGLAS LLP;ATTN: PATENT DOCKET DEPT., 191 N. WACKER DRIVE, SUITE 3700, CHICAGO, IL, 60606, US

(73) Assignee: Samsung Techwin Co., Ltd., Changwon-city (KR)

(21) Appl. No.: 11/473,775

(22) Filed: Jun. 23, 2006

(30) Foreign Application Priority Data
Sep. 7, 2005 (KR) 10-2005-0083426

(51) Int. Cl. H04N 5/222

(52) U.S. Cl. 348/333.12

(57) ABSTRACT

Provided are a digital image processing apparatus which can control the size of a display, and accordingly control a picture format, and a method of displaying an image. The digital image processing apparatus includes: a display on which a preview image of an object to be photographed or a reproduced image is displayed; a cover element configured to selectively cover a portion of the display; and an image controlling unit which outputs a signal to the display, the signal corresponding to a picture format that is determined according to an orientation of the cover element and, therefore, a size of the display that is exposed.

### CROSS-REFERENCE TO RELATED PATENT APPLICATIONS

This application claims the priority of Korean Patent Application No. 10-2005-0083426, filed on Sep. 7, 2005, in the Korean Intellectual Property Office, the disclosure of which is incorporated herein in its entirety by reference.

### BACKGROUND OF THE INVENTION

1. Field of the Invention

The present invention relates generally to a digital image processing apparatus and a method of displaying an image thereon, and more particularly, to a digital image processing apparatus including a large display and a method of displaying an image thereon so that an image having high visibility is displayed during photographing or reproducing the image, and photographing information of the image can be easily seen.

2. Description of the Related Art

FIG. 1 is a rear view of a typical conventional digital camera 50. Referring to FIG. 1, a display 61 such as a liquid crystal display (LCD) is located on the rear of a main body 51 of the digital camera 50. A control unit 71 is also located on the rear of the main body 51 beside the display 61. The control unit 71 includes a plurality of control elements such as buttons, switches, dials or the like that enable a user of the digital camera 50 to perform certain functions of the digital camera 50. The control elements are used for photographing, reproducing, or editing an image and include, for example, an enlarge/reduce button 72, four directional keys 73, a menu button 74, and a self-timer button 75.

As shown in FIG. 1, the control unit 71 is disposed at one side (i.e., the right side) of the display 61, but may be located elsewhere on the rear of the main body 51. Since the control unit 71 occupies an area on the rear of the main body 51, the size of the display 61 is small, and consequently, the visibility of an image displayed on the display 61 is reduced. Photographing information or reproducing information, for example, a histogram 81, remaining battery life 82, a photographing mode 83, aperture information 85, and a shutter speed are also often displayed on the display 61. However, such photographing information or reproducing information is not easily distinguishable because it is displayed together with a preview image or a reproduced image.

To solve the problem of distinguishing image information from the displayed image, a digital camera 50′ as shown in FIG. 2 may further include an additional display 80 beside the display 61 on which a preview image or a reproduced image is displayed. Photographing information or reproducing information (e.g., remaining battery life 82, a photographing mode 83 and aperture information 85 as shown) is displayed on the additional display 80. Although the additional display 80 could be configured elsewhere on the main body 51 (e.g., on the top adjacent a shutter release button), it is desired for the user to be able to view the image and image information substantially simultaneously. To this end, the size of the display 61, in which the preview image or the reproduced image is displayed, is further reduced compared to the display 61 of FIG. 1, since the additional display 80 is added to the rear of the main body 51. Furthermore, the additional display 80 adds complexity to the camera 51′ compared to the camera 50 since the display 61 and the additional display 80 need to be separately controlled. Consequently, the manufacturing cost of the digital camera 50′ is greater than the manufacturing cost of digital camera 50.

### SUMMARY OF THE INVENTION

The present invention provides a digital image processing apparatus capable of simultaneously controlling the size of a display and picture format, and a method of displaying an image.

The present invention also provides a digital image processing apparatus having a display to separately display photographing information so that the photographing information can be easily recognized, and a method of displaying an image.

According to an aspect of the present invention, there is provided a digital image processing apparatus, including: a display on which a preview image of an object to be photographed or a reproduced image is displayed; a cover element configured to selectively reveal or cover a portion of the display; and an image controlling unit which outputs a signal to the display, the signal corresponding to a picture format determined according to a size of a display according to a location or state of the cover element.

According to another aspect of the present invention, there is provided a digital image processing apparatus, including: a display which displays at least one of a preview image of an object to be photographed and a photographed reproduced image; a cover element configured to selectively reveal or cover a portion of the display; and an image controlling unit which formats the preview image or the reproduced image for displaying on the display in a display region, which has a predetermined aspect ratio and a size according to a location or state of the cover element.

According to another aspect of the present invention, there is provided a method of displaying an image. The method includes: outputting a picture format signal corresponding to an aspect ratio of a first display region when only the first display region of a display is revealed, the display displaying at least one of a preview image of an object to be photographed and a photographed reproduced image; and outputting a picture format signal corresponding to an aspect ratio of a combination of the first display region and a second display region when the first and second display regions are both revealed.

### BRIEF DESCRIPTION OF THE DRAWINGS

The above and other features and advantages of the present invention will become more apparent by describing in detail exemplary embodiments thereof with reference to the attached drawings in which:

FIG. 1 is a rear view of a conventional digital camera;

FIG. 2 is a rear view of another conventional digital camera;

FIG. 3 is a rear perspective view of a digital image processing apparatus according to an embodiment of the present invention;

FIG. 4 is a view of the digital image processing apparatus of FIG. 3 in which a cover element is moved from the state illustrated in FIG. 3;

FIG. 5A is a rear perspective view of a digital image processing apparatus according to another embodiment of the present invention;

FIG. 5B is a front perspective view of the digital image processing apparatus of FIG. 5A;

FIG. 6A is a view of the digital image processing apparatus illustrated in FIG. 5A in which a cover element is moved from the state illustrated in FIG. 5A;

FIG. 6B is a view of the digital image processing apparatus illustrated in FIG. 5B in which a cover element is moved from the state illustrated in FIG. 5B;

FIG. 7 is a block diagram of a digital image processing apparatus according to an embodiment of the present invention;

FIG. 8 is a rear view of a digital image processing apparatus in which a cover element is located at a first location;

FIG. 9 is a rear view of the digital image processing apparatus of FIG. 8 in which the cover element is located at a second location;

FIG. 10 is a rear view of a modified version of the digital image processing apparatus illustrated in FIG. 9 according to an embodiment of the present invention;

FIG. 11 is a rear view of another modified version of the digital image processing apparatus illustrated in FIG. 9 according to an embodiment of the present invention;

FIG. 12 is a rear view of a digital image processing apparatus according to another embodiment of the present invention, in which a cover element is located at a first location;

FIG. 13 is a rear view of the digital image processing apparatus of FIG. 12, in which the cover element is located at a second location; and

FIG. 14 is a block diagram illustrating a structure of the digital image processing apparatus of FIG. 12.

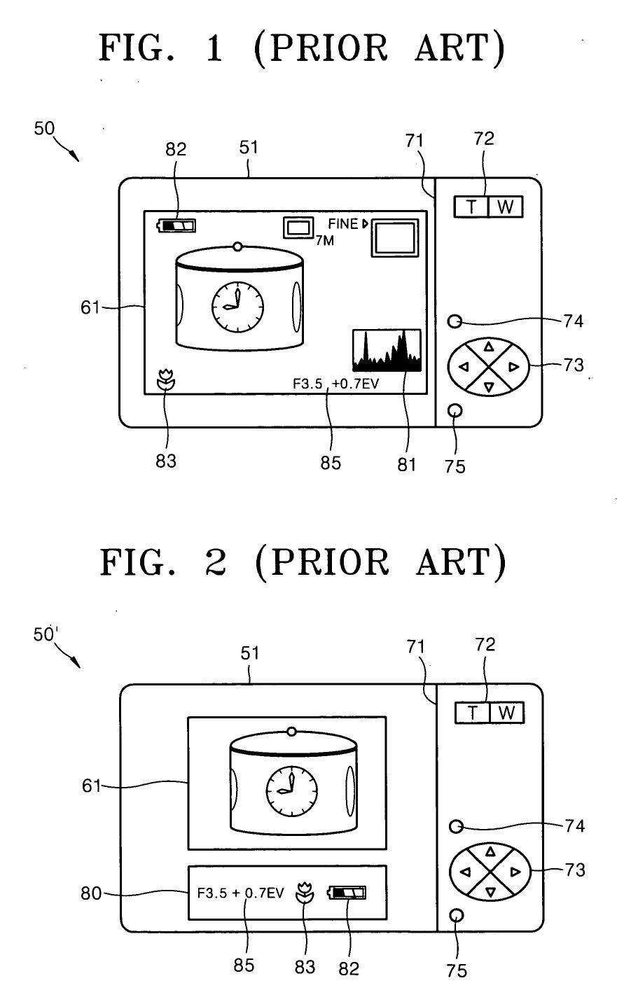

### DETAILED DESCRIPTION OF THE EMBODIMENTS

The present invention will now be described more fully with reference to the accompanying drawings, in which exemplary embodiments of the invention are shown.

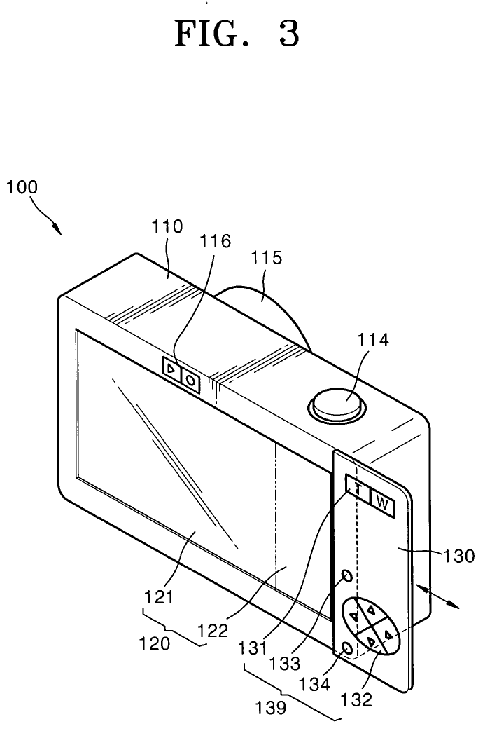

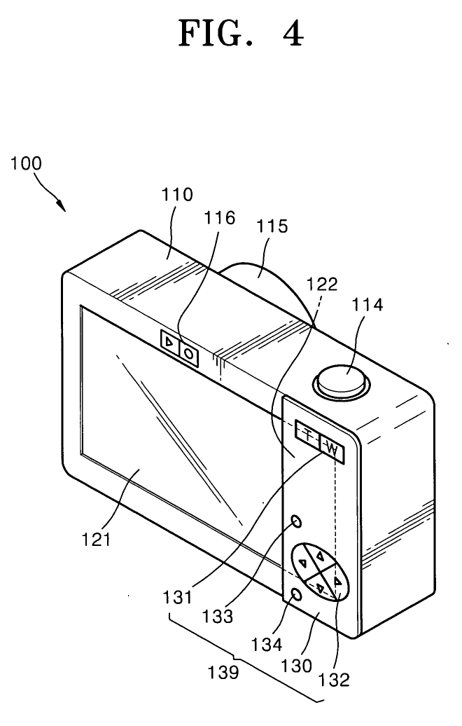

FIG. 3 is a perspective view of a rear of a digital image processing apparatus 100, according to an embodiment of the present invention, and FIG. 4 is a perspective view of a rear of the digital image processing apparatus 100 in which a cover element 130 is moved from the state illustrated in FIG. 3.

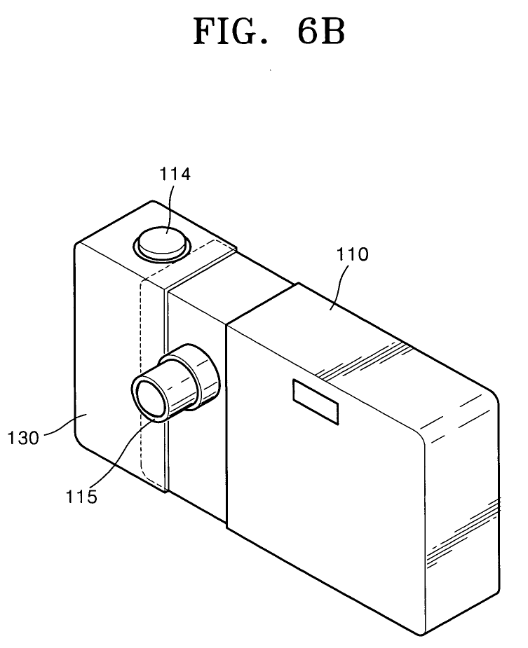

The digital image processing apparatus 100 includes a main body 110, a display 120, the cover element 130, and an image controlling unit 150 (shown FIG. 7). The main body 110 may be any suitable shape, for example, a hexahedron, a sphere, or a parallelepiped in which a front surface and a rear surface are configured to form two parallel planes, or the like. A lens unit 115 may be placed at the front of the main body 110, a shutter release button 114 may be placed on top of the main body 110, and a reproduce/photograph select button 116 may be placed at the rear of the main body 110.

The display 120 is disposed at the rear of the main body 110. The display 120 is a display device, for example, a Liquid Crystal Display (LCD) or an Organic Light Emitting Diodes (OLED) display. When an OLED display is used, an EL light of the covered region (i.e., the light that illuminates the display region 122 which is selectively covered by the cover element 130) can be turned off when moving the cover element 130, thereby reducing power consumption by the display 120. Furthermore, although the display regions 121 and 122 are illustrated as being portions of display 120, display regions 121, 122 may alternatively be adjacent, separate, individually-controllable displays so that the display region 122 may be turned off for conserving power. As can be appreciated from FIG. 3, since the control elements 139 are configured on the cover element 130, the display 120 can be substantially similar in size as the rear surface of the main body 110. The display 120 displays a preview image in a photographing mode or a reproduced (i.e., stored) image in a review or playback mode.

As can be appreciated from FIGS. 3 and 4, the cover element 130 is configured to selectively reveal or cover a region (region 122 as shown) of the display 120. The cover element 130 is movably coupled to the main body 110 so that the size of the display 120 that is exposed changes as the cover element 130 moves. That is, the size of the display 120 changes depending on the location or orientation of the cover element 130. In accordance with the location or orientation of the cover element 130, the image controlling unit 150 outputs to the display 120 a signal corresponding to displaying an image in a suitable picture format for the size of the display 120.

For example, when the cover element 130 is moved to expose the entire display 120 as illustrated in FIG. 3, the preview or reproduced image can be displayed in a larger size on both regions 121, 122 of the display 120. Furthermore, if the preview or reproduced image does not need to be seen in a larger size, the cover element 130 may be moved or otherwise oriented to cover the region 122 of the display 120, as illustrated in FIG. 4 so that only the region 121 of the display 120 is exposed. Advantageously, when the display 120 is an OLED display, an EL light illuminating the covered region 122 can be turned off, thereby reducing power consumption. Similarly, in embodiments of the apparatus 100 where the display regions 121 and 122 are adjacent, separate, individually-controllable displays, the display region 122 may be turned off to conserve power.

The cover element 130 may be slidably coupled to the main body 110 so that the size of the display 120 is changed as the cover element 130 slides on the main body 110. As illustrated in FIGS. 3 and 4, the cover element 130 may be coupled only to the rear surface of the main body 110 to slide thereon. In other embodiments, the cover element 130 may be coupled to the main body 110 via a common slide element, such as, for example, a slide mechanism used for a sliding type mobile phone or the like.

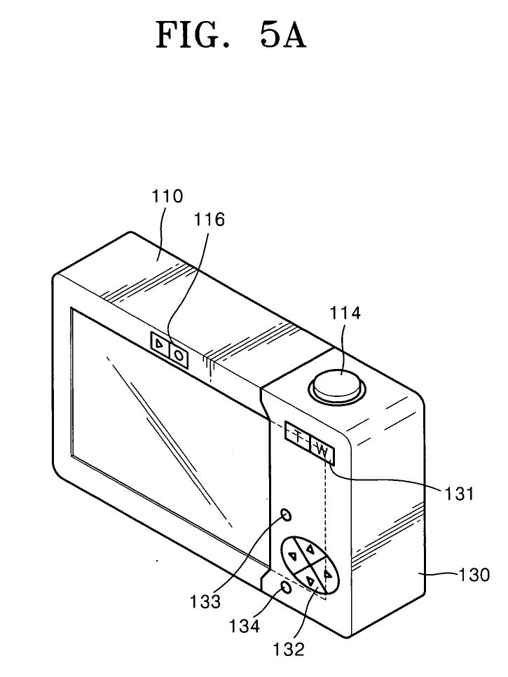

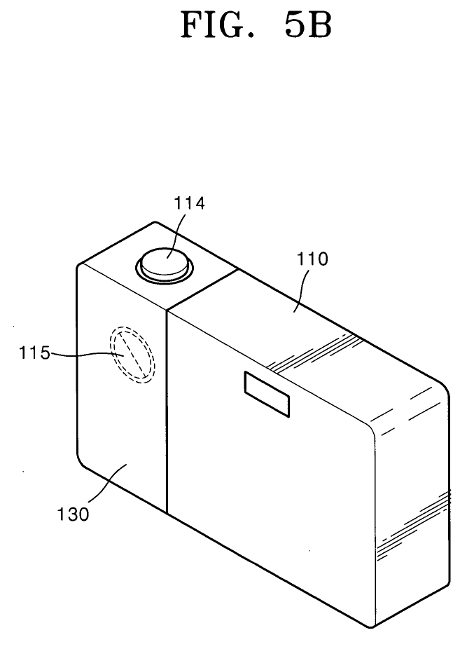

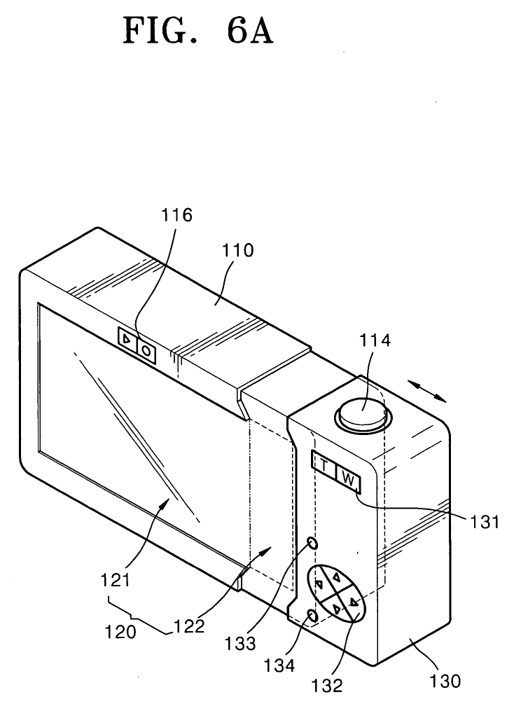

Alternatively, in another embodiment of the apparatus 100 illustrated in FIGS. 5A through 6B, the cover element 130 may comprise a portion of the main body 110 and telescope or otherwise move relative to the portion of the main body 110 including the display 120 so that the apparatus 100 expands and contracts (e.g., in length as best illustrated in FIG. 6A). That is, as can be appreciated from FIGS. 6A and 6B, the cover element may include front, rear, top, bottom and end (i.e., sidewall) portions that slide over a portion of the main body 110.

Furthermore, as can be appreciated from FIGS. 5A, 5B, 6A and 6B, when the cover element 130 covers the region 122 of the display 120 as illustrated in FIG. 5A, the lens unit 115 that is disposed at the front of the main body 110 is covered by the cover element 130 and does not protrude from the main body 110 for photographing. When the cover element 130 slides to expose the portion 122 of the display 120, as illustrated in FIG. 6A, the cover element 130 is moved away from the lens unit 115 as shown in FIG. 6B so that the lens unit 115 can protrude from the main body 110 for photographing. However, the cover element 130 is not limited to the illustrated embodiments herein and may be configured otherwise so that the lens unit 115 may protrude from the main body 110 even when the cover element 130 is covering the display region 122. Thus, the lens unit 115 can be controlled to be in a photographable state or an unphotographable state independent of the location of the cover element 130. In yet another embodiment, the lens unit 115 may be configured on the main body so that it is distal from the cover element 130.

Although not illustrated, the cover element 130, particularly the cover element 130 shown in FIGS. 34, can be coupled to the main body 110 via a hinge, pivot or other mechanism known in the art that allows movement of the cover element 130 relative to the main body 110. For example, the entire display 120 may be exposed by rotating the cover element 130 in a predetermined direction around the hinge or pivot. Conversely, the region 122 of the display 120 may be covered by rotating or pivoting the cover element 130 in an opposite direction to the predetermined direction. The hinge may be placed, for example, along the entire length of one side (i.e., the right side) of the main body 110.

As illustrated in FIGS. 3 through 6B, a plurality of control elements 139 may be disposed on the cover element 130, thereby maximizing the size of the display 120 on the rear of the main body 110. The control elements 139 are buttons for photographing, reproducing, or editing an image, and may include one or more of the following as shown (as well as others known in the art): an enlarge/reduce button 131, four directional keys 132, a menu button 133, and a self-timer button 134.

FIG. 7 is an example block diagram of a digital image processing apparatus according to an embodiment of the present invention. Elements in FIG. 7 that are the same as the elements in FIGS. 3 through 6B are labeled with the same reference numbers.

The digital image processing apparatus includes a zoom lens 1, an iris (i.e., an aperture) 2, a focus lens 3, an imaging device (e.g., a Charge Coupled Device (CCD)) 4, a zoom motor 5, an iris motor 6, a focus motor 7, and a Correlated Double Sampling (CDS)/Automatic Gain Control (AGC) circuit 9. The zoom lens 1, the iris 2, the focus lens 3, and the imaging device 4 form a photographing unit which photographs an object.

The iris motor 6 includes an aperture variation unit which changes the size of the aperture. The CDS/AGC circuit 9 includes a gain variable unit which changes the degree of amplification of an image signal output by the imaging device 4. The iris motor 6 and the CDS/AGC circuit 9 include an exposure change element which changes the exposure state of the imaging device 4.

The zoom lens 1 is moved by the zoom motor 5, the iris motor 6 controls the aperture size of the iris 2, and the focus motor 7 controls the location of the focus lens 3. The light reflected from the object passes through the zoom lens 1, the iris 2, and the focus lens 3, and is then focused on a light receiving surface of the imaging device 4.

The imaging device 4 optical converts the light focused on the light receiving surface. A CCD imaging device or a CMOS imaging device may be used as the imaging device 4. A color filter is disposed on a front surface of the imaging device 4. The color filter may be a primary color filter including red, green, and blue colors, or may be a complementary color filter including cyan, magenta, and yellow colors. The imaging device 4 may be driven by a timing signal output from a timing generator (not shown).

The digital image processing apparatus also includes an A/D converter 10, an image input controller 11, an image signal processing circuit 12, an image compression/extension circuit 13, a video encoder 14, a display 120, motor drivers 16, 17, and 18, an image controlling unit 150 (e.g., a CPU), a control element 139, a memory 22, a video RMA (VRAM) 23, a media controller 24, and a recording medium 25.

The image controlling unit 150 controls the digital image processing apparatus by controlling automatic exposure (AE) or automatic focusing (AF) based on conditions set using the control element 139 and the output of the imaging device 4.

The image controlling unit 150 receives an input signal that is output from the control element 139. In response to the input signal, the image controlling unit 150 may output a zoom driving signal to move the zoom lens 1, a focus driving signal to move the focus lens 3, an iris driving signal to open or close the iris 2, and a gain control signal to control the gain of the CDS/ACG circuit 9.

The image signal output by the imaging device 4 is transmitted to the A/D converter 10 via the CDS/ACG circuit 9, and is digitalized in the A/D converter 10. An output signal of the A/D converter 10 is stored in the image controlling unit 150 via the image input controller 11, and may also be temporarily stored in the memory 22.

The image signal output by the imaging device 4, which was transmitted to the A/D converter 10 via the CDS/AGC circuit 9 and digitalized in the A/D converter 10, is transmitted to the image signal processing circuit 12 from the image input controller 11. Image processing such as gamma compensation, edge enhancement, and white balance are performed in the image signal processing circuit 12. Thereafter, the image signal is transmitted to the video encoder 14. A component color video signal is generated in the video encoder 14, and the component color video signal is transmitted to the VRAM 23. Then, the component color video signal may be transmitted to one or more display regions 121, 122 of the display 120 to display, for example, a preview image (i.e., an image to be photographed).

The image controlling unit 150 controls, for example, the image signal processing circuit 12 to display On-Screen Display (OSD) information (i.e., photographing information) such as aperture size and shutter speed in a top area of the reproduced image displayed on the display 120 or in a separate display region of the display 120. Image data for a single image stored in the memory 22 is accessed and image-processed in the image signal processing circuit 12 and then transmitted to the image compression/extension circuit 13. The image compression/extension circuit 13 compresses and encodes image data. The image data may be compressed according to the Joint Photographic Experts Group (JPEG) standard, which uses Discrete Cosine Transform (DCT) for image compression. However, other compression methods may be used.

The compressed and encoded image signal is transmitted to the recording medium 25 via the media controller 24 and is stored in the recording medium 25. In some embodiments of the apparatus, the recording medium 25 may be a detachable memory such as a flash memory card. The recording medium 25 may alternatively or additionally be a nonvolatile memory, a magnetic tape, a magnetic disc, or an optical disc.

When reproducing an image (i.e., displaying a stored, photographed image), an image file recorded in the recording medium 25 is accessed and image data is read from the recording medium 25. The image data read from the recording medium 25 is then transmitted to the image compression/extension circuit 13. The image data is extension-based processed in the image compression/extension circuit 13. An output of the compression/extension circuit 13 is then transmitted to the video encoder 14, and an output signal of the video encoder 14 is transmitted to a first display region 121, a second display region 122, or the entire display 120 comprising both regions 121, 122 to display a reproduced image. The structure of the digital image processing apparatus is not limited, however, to the above description, and may be realized in many other ways.

The cover element 130 may be moved by hand or by a motor coupled to a driver that is controlled by the image controlling unit 150 so that the cover element 130 is located to expose or cover a portion of the display 120. As shown, the apparatus may include an open/close sensor 153 that detects the location of the cover element 130 and outputs a signal to the image controlling unit 150. In response to the signal received from the open/close sensor 153, the image controlling unit 150 may control the formatting and outputting of image data or an image signal for displaying on a region 121, 122 or an entirety of the display 120 according at least one of first, second, third, fourth, and fifth mode picture format signals 161, 162, 163, 164, and 165. Alternatively, a user may actuate at least one of first, second, third, fourth, and fifth mode picture format signals 161, 162, 163, 164, and 165 by manually moving a switch or pressing a button, for example an actuator of control element 139.

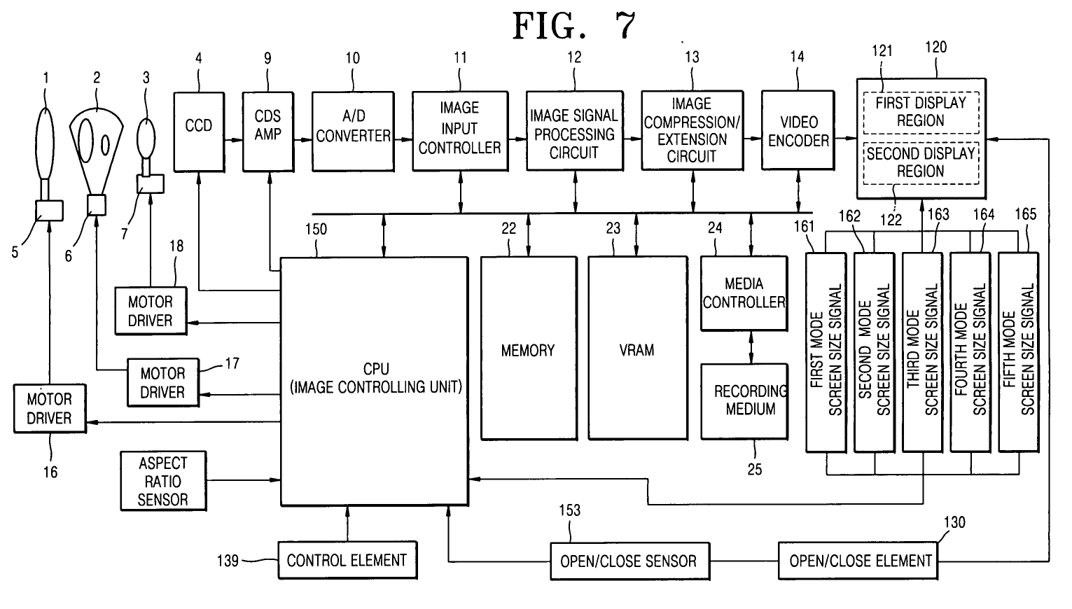

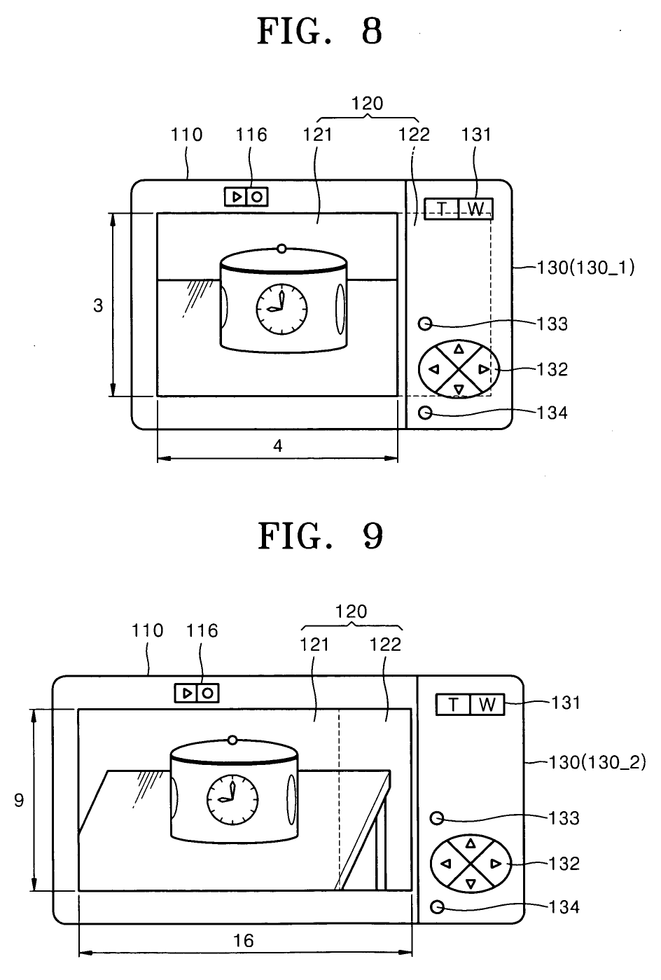

Turning now to FIGS. 8 and 9, the digital image processing apparatus 100 of FIGS. 3 and 4 are further illustrated when the cover element 130 is respectively disposed at a first location 130_1 where a portion of a display 120 is covered, and a second location 130_2 where the entire display 120 is uncovered, exposed or otherwise revealed. When the cover element 130 is at the second location 130_2, the cover element 130 may protrude from the main body 110 (e.g., to the right as shown). The display 120 includes the first display region 121 which is always exposed (i.e., region 121 is revealed regardless of whether the cover element 130 is located at the first location 130_1 or the second location 130_2) and the second display region 122 which is covered by the cover element 130 when the cover element 130 is located at the first location 130_1.

In more detail, an image (e.g., a preview image or a reproduced image) is displayed only in the first display region 121 when the cover element 130 is located at the first location 130_1 as illustrated in FIG. 8. Furthermore, an image may be displayed only in the first display region 121 or in both of the first and second regions 121 and 122 when the cover element 130 is located at the second location 130_2. That is, the size of the image that is to be displayed can be altered depending on the size of the display 120 that is revealed or covered by the cover element 130. More specifically, as the size of the revealed region of the display 120 changes, the size and aspect ratio of the image being displayed can be adjusted, for example, dynamically relative to the location of the cover element 130, thereby making it easier to see the displayed image.

Although not illustrated in FIG. 8, when the cover element 130 is at the first location 130_1, the image controlling unit 150 may control the display 120 so that the first display region 121 is divided into a standard region where the image is displayed and an information region where information (e.g., photographing information or reproducing information) is displayed. In other words, when the cover element 130 is located at the first location 130_1, the size of the revealed region of the display 120 is reduced. Consequently, if the preview image or the reproduced image and the photographing information or reproducing information are displayed such that they overlap with each other, it is difficult to clearly recognize the photographing information.

Meanwhile, the image controlling unit 150 can output the first mode picture format signal 161 and the second mode picture format signal 162 to the display 120. The first mode picture format signal 161 is for displaying the preview image or the reproduced image in the first display region 121, and the second mode picture format signal 162 is for displaying the preview image or the reproduced image in the first and second display regions 121 and 122. For example, the first display region 121 may have an aspect ratio of 4:3, and the constitution of the first and second display regions 121 and 122 may have an aspect ratio of 16:9. Accordingly, the aspect ratio of the first mode picture format may be 4:3, and the aspect ratio of the second mode picture format may be 16:9.

When the cover element 130 is located at the first location 130_1, the preview image or the reproduced image may be displayed on the display 120 in response to the first mode picture format signal 161. In other words, the preview image or the reproduced image can be displayed in the first display region 121.

When the cover element 130 is located at the second location 130_2, the image controlling unit 150 may output the second mode picture format signal 162 to the display 120, regarding changing the displayed format the preview image or the reproduced image. That is, the preview image or the reproduced image may be enlarged and displayed in the entire area (i.e., the first and second display regions 121 and 122) of the display 120.

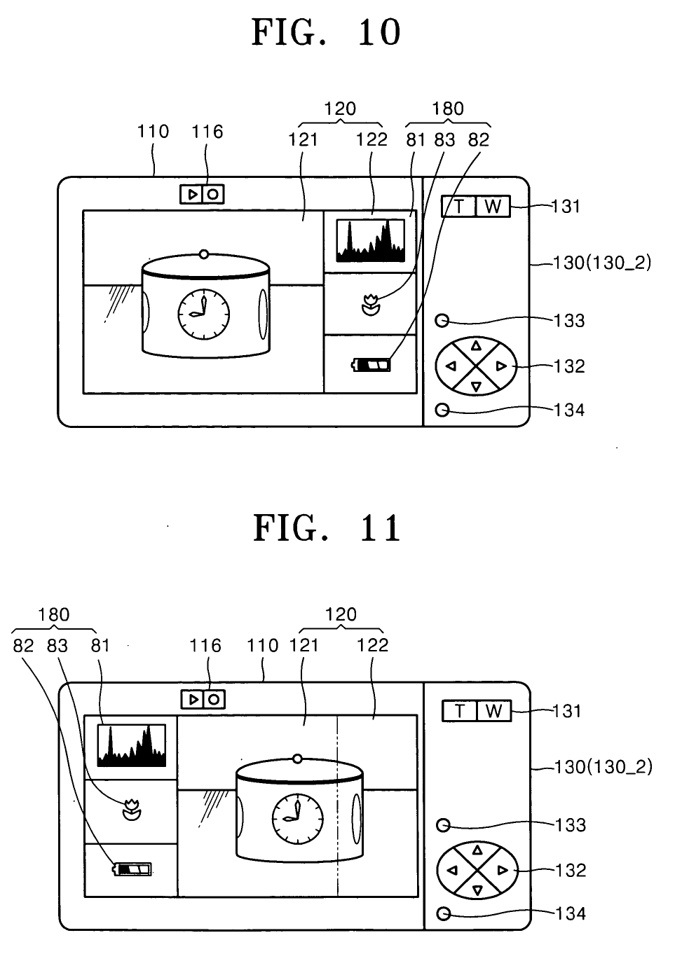

Referring now to FIG. 10, the image controlling unit 150 outputting the third mode picture format signal 163 to the display 120 is discussed. The third mode picture format signal 163 is for displaying information in the second display region 122 in the same aspect ratio as the second display region 122. In this case, when the cover element 130 is moved from the first location 130_1 to the second location 130_2, the image controlling unit 150 outputting to the display 120 the first mode picture format signal 161 for displaying the image in region 121 now outputs to the display 120 the third mode picture format signal 163 for displaying photographing information or the reproducing information 180 in the region 122 only. That is, the preview image or the reproduced image can be displayed in the first display region 121 and the photographing information or the reproducing information 180 can be displayed in the second display region 122. As a result, the photographing information or the reproducing information 180 and the displayed image do not overlap each other. The photographing information or the reproducing information 180 includes information related to photographing, reproducing, or editing an image such as a histogram 81, a remaining battery life 82, a photographing mode 83, aperture information, a shutter speed, and a thumbnail image.

In another embodiment of the present invention, the photographing information or the reproducing information 180 may alternatively be displayed in the first display region 121 (e.g., a portion of region 121) rather than in the second display region 122.

For example, FIG. 11 illustrates when the image controlling unit 150 outputs the fourth and fifth mode picture format signals 164 and 165 to the display 120. The fourth mode picture format signal 164 has the same aspect ratio as the first display region 121 and is for displaying an image in a portion of the first display region 121 and the entire second display region 122, and further displaying the information 180 in the other portion of the first display region 121. The fifth mode picture format signal 165 designates an aspect ratio equal to the aspect ratio of the second display region 122 and is for displaying an image in the first display region 121. Therefore, when the cover element 130 is located at the second location 130_2, the image controlling unit 150 outputs the fourth mode picture format signal 164 to the display 120 for displaying the preview image or the reproduced image and outputs the fifth mode picture format signal 165 to the display 120 for displaying the photographing information or the reproducing information 180. As can be appreciated by comparing FIG. 10 to FIG. 11, when the controlling unit 150 is outputting the third mode picture format signal 163, the orientations of the image and information 180 being displayed on the display 120 can be switched by outputting the fourth and fifth mode picture format signals 164, 165.

However, the present invention is not limited to the above description, and the image controlling unit 150 can output other mode picture format signals to the display 120 so that the photographing information or the reproducing information can be displayed together with an image (e.g., the preview image or the reproduced image).

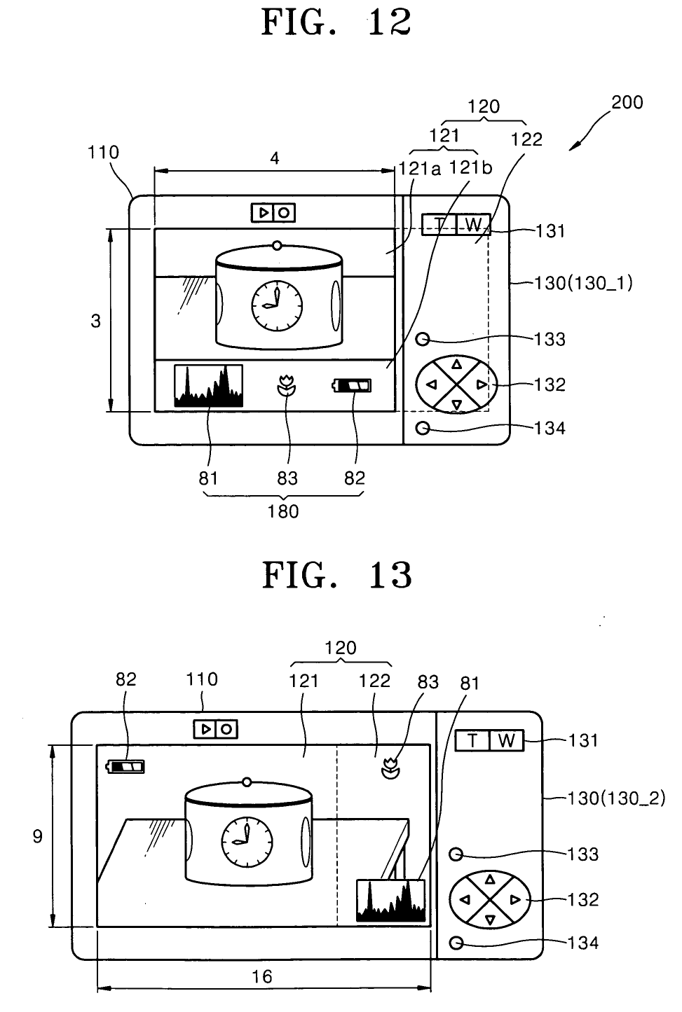

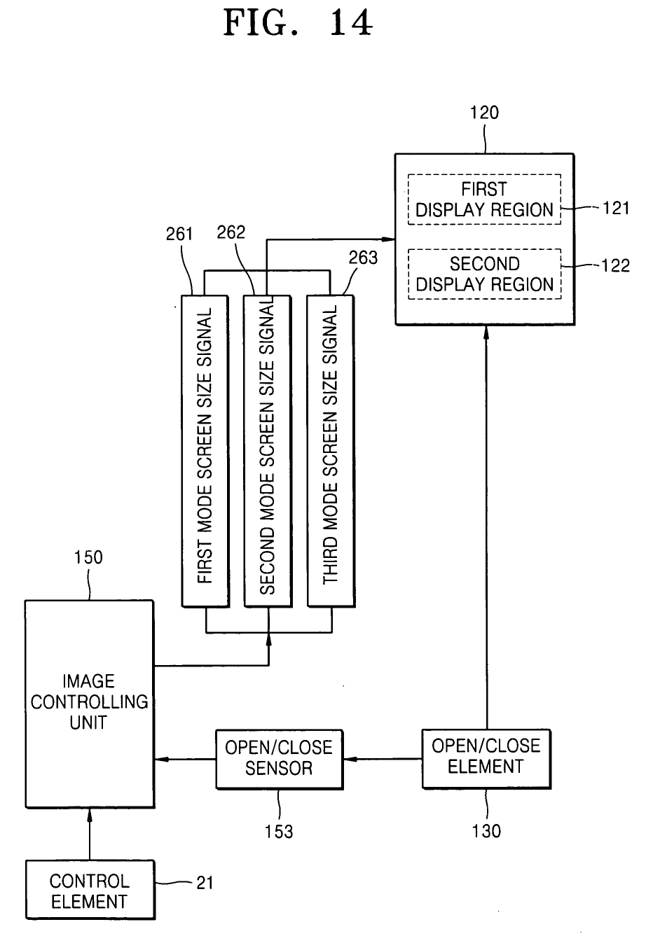

FIG. 12 is a rear view of a digital image processing apparatus 200 according to another embodiment of the present invention, in which a cover element 130 is movable and located at a first location 130_1. FIG. 13 is a rear view of the digital image processing apparatus 200 of FIG. 12 in which the cover element 130 has been moved to a second location 130_2. FIG. 14 is an example block diagram illustrating the structure of the digital image processing apparatus 200.

An image controlling unit 150 (see FIG. 14) included in the digital image processing apparatus 200 controls a display 120 so that the display 120 can display an image (e.g., a preview image or a reproduced image) in regions of the display 120 having different picture formats but the same aspect ratio, depending on the size of the display 120 that is exposed.

In other words, the cover element 130 may be located at the first location 130_1 (see FIG. 12) where a portion (e.g., region 121) of the display 120 is exposed, or may be located at the second location 130_2 (see FIG. 13) where the entire display 120 (including regions 121 and 122) is exposed. Accordingly, the display 120 can include a first display region 121 that is exposed whether the cover element 130 is located at the first location 130_1 or the second location 130_2, and a second display region 122 that is selectively covered by the cover element 130 and is exposed when the cover element 130 is located at the second location 130_2.

In the present embodiment, the image controlling unit 150 can output a first mode picture format signal 261, a second mode picture format signal 262, and a third mode picture format signal 263 to the display 120 as best illustrated in FIG. 14. The first mode picture format signal 261 is for displaying the preview image or the reproduced image on the first display region 121 with an aspect ratio corresponding to a display 120. The second mode picture format signal 262 is for displaying the preview image or the reproduced image on the display 120 with an aspect ratio corresponding to the display 120. The third mode picture format signal 263 will be described in detail after the first and second mode picture format signals 261, 262.

With regards to FIG. 13 where the entire display 120 (comprising regions 121 and 122) is exposed, assuming that: 1) the display 120 has an aspect ratio of 16:9 and 2) the first display region 121 has an aspect ratio of 4:3, the aspect ratio of the second mode picture format 262 is 16:9 since it has the same aspect ratio as the display 120. Thus, by outputting the second mode picture format 262 when the cover element 130 is located at the second location 130_2, the image (e.g., preview image or the reproduced image) is displayed in the first and second display regions 121 and 122 with an aspect ratio of 16:9.

With respect to FIG. 12, when the cover element 130 is located at the first location 130_1, the image (e.g., preview image or the reproduced image) may be displayed only on the region 121. Accordingly, the image being displayed on the region 121 has an aspect ratio of 16:9, that is, the image has the same aspect ratio as when the cover element 130 is located at the second location 130_2. Therefore, the image being displayed can be enlarged or reduced while maintaining the same aspect ratio simply by, for example, moving the cover element 130.

In the present embodiment, the first display region 121 has an aspect ratio of 4:3. Thus, when the cover element 130 is located at the first location 130_1 so that the image is displayed with an aspect ratio of 16:9 on the region 121, the first display region 121 includes a peripheral region 121b (in addition to a region 11a having an aspect ratio of 16:9 in which the image is displayed) after the display 120 receives the first mode picture format signal 261. Information (e.g., photographing information or the reproducing information) may be displayed in the peripheral region 121b of the first display region 121 as shown in FIG. 12.

To display the information in the peripheral region 121b, the image controlling unit 150 can output a third mode picture format signal 263 to the display 120. The third mode picture format signal 263 is for displaying an image (e.g., information) in the peripheral region 121b in an aspect ratio corresponding to the peripheral region 121b. In this case, after the display 120 receives the third mode picture format signal 263, it can display photographing information or reproducing information (e.g., including icons, images and indicia) in the peripheral region 121b. As a result, the photographing information or the reproducing information images does not overlap the preview image or the reproduced image being displayed in region 11a so that a separate display 120 is not required. Therefore, an image can be clearly shown together with the information relative to the displayed image. When the cover element 130 is moved to enlarge the display 120, the information being displayed in region 121b may be displayed on display 120, for example, in an overlapping and/or semi-transparent manner with the image being displayed as shown in FIG. 13.

A method of displaying an image according to an embodiment of the present invention includes: revealing the first display region 121 of the display 120; and outputting a picture format signal to the first display region 121, the picture format signal having an aspect ratio corresponding to the first display region 121, as illustrated in FIGS. 3 through 13. The method further includes: exposing the first region 121 and the second region 122; and outputting a picture format signal to the display 120, the picture format signal having an aspect ratio corresponding to the combination of the first and second display regions 121 and 122.

In other words, the designated picture format may increase automatically as the size of the display region of the display 120 increases. Conversely, the designated picture format may decrease automatically as the size of the display region of the display 120 decreases. Alternatively, the picture format can be manually changed by a user.

When only the first display region 121 is exposed or when the first and second display regions 121 and 122 are exposed, aspect ratios of the displays (i.e., region 11a and entire display 120) on which the preview image or the reproduced image are displayed can be the same. In addition, when the first display region 121 is exposed, photographing information or reproducing information images can be displayed in a region (e.g., region 121b) besides a region (e.g., region 121a) in which the preview image or the reproduced image is displayed.

According to the present invention, visibility of a preview image or a reproduced image is improved since the size of a display can be changed by a user, and thus the size of various images displayed on the display can be changed according to the location or orientation of the cover element 130 and the corresponding size of the display.

In addition, photographing information can be clearly shown in a display region separate from the display region where the preview image or the reproduced image is displayed.

Furthermore, the manufacturing costs of a digital image processing apparatus can be reduced since a single display region is divided into the separate display regions.

Also, although the embodiments of the present invention have been described with respect to a digital camera as an example of a digital image processing apparatus, the present invention is not limited to this.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A digital image processing apparatus, comprising:
a display;
a cover element for covering the display, wherein the cover element can move from a position of covering a portion of the display to another position of uncovering the portion of the display; and
an image controlling unit for displaying on the display a plurality of non-overlapping display regions, wherein a first one of the plurality of non-overlapping display regions is for displaying an image of an object and a second one of the plurality of non-overlapping display regions is for displaying photographic information relating to the image, and wherein an arrangement of the plurality of non-overlapping display regions varies in accordance with an amount of the display uncovered by the cover element.

2. The digital image processing apparatus of claim 1 further comprising a sensor in communication with the image controlling unit, the sensor detecting an orientation of the cover element and outputting an orientation signal indicative of the orientation to the image controlling unit, and wherein the image controlling unit varies a display signal for controlling the display relative to the orientation signal.

3. The digital image processing apparatus of claim 1 wherein the plurality of non-overlapping display regions comprises:
a first aspect display region having a first aspect ratio; and
a second aspect display region adjacent the first aspect display region and having a second aspect ratio different from the first aspect ratio, wherein one of the first and second aspect display regions is selectively exposed by the cover element.

4. The digital image processing apparatus of claim 3 wherein the image controlling unit, according to the orientation of the cover element, varies an aspect ratio of the display signal to be at least one of the first aspect ratio, the second aspect ratio and an entire aspect ratio of the display.

5. The digital image processing apparatus of claim 1 wherein the image controlling unit is further configured to change an operating mode of the digital image processing apparatus according to the orientation of the cover element.

6. The digital image processing apparatus of claim 1 wherein the cover element comprises at least one control element.

7. The digital image processing apparatus of claim 1 wherein the image controlling unit is further configured to protrude or retract a lens unit according to the orientation of the cover element.

8. A camera, comprising:
a display;
a lens unit;
a cover element for covering the display, wherein said cover element can move from a position of covering the display to another position of uncovering the display;
an image controlling unit for displaying on the display a plurality of non-overlapping display regions, wherein a first one of the plurality of non-overlapping display regions displays an image of an object and a second one of the plurality of non-overlapping display regions displays photographic information relating to the image, and wherein an arrangement of the plurality of non-overlapping display regions varies in accordance with an amount of the display uncovered by the cover element.

9. The camera of claim 8 further comprising a sensor in communication with the image controlling unit, the sensor detecting an orientation of the cover element and outputting an orientation signal indicative of the orientation to the image controlling unit, and wherein the image controlling unit varies a display signal for controlling the display relative to the orientation signal.

10. The camera of claim 8 wherein the plurality of non-overlapping display regions comprises:
a first aspect display region having a first aspect ratio; and
a second aspect display region adjacent the first aspect display region and having a second aspect ratio different from the first aspect ratio, wherein one of the first and second aspect display regions is selectively exposed by the cover element.

11. The camera of claim 10 wherein the image controlling unit, according to the orientation of the cover element, varies an aspect ratio of the display signal to be at least one of the first aspect ratio, the second aspect ratio and an entire aspect ratio of the display.

12. The camera of claim 8 wherein the image controlling unit is further configured to change an operating mode of the digital image processing apparatus according to the orientation of the cover element.

13. The camera of claim 8 wherein the cover element comprises at least one control element.

14. The camera of claim 8 wherein the image controlling unit is further configured to protrude or retract a lens unit according to the orientation of the cover element.

15. The camera of claim 8 wherein an aspect ratio of the display is substantially similar to one of the first and second aspect ratios, and wherein, upon detecting movement of the cover element from covering the display to the uncovering the display, the image controlling unit enlarges the image being displayed on the display.

16. The camera of claim 8 further comprising a sensor in communication with the image controlling unit and configured to detect the cover element being in at least one of a position of covering the display and a position of uncovering the display, the sensor further configured to output an orientation signal indicative of the orientation of cover element in relation to the display to the image controlling unit, and wherein the image controlling unit varies the aspect ratio of the image being displayed on the display relative to the orientation signal.

17. The camera of claim 8 wherein the display is configured to occupy substantially an entire side of the camera.

18. A method of displaying an image on a display of a digital image processing apparatus, comprising:
covering a display with a cover element, wherein the cover element can move from a position of covering the display to another position of uncovering the display;
displaying on the display a plurality of non-overlapping display regions;
displaying an image of an object on a first one of the plurality of non-overlapping display regions;
displaying photographic information relating to the image on a second one of the plurality of non-overlapping display regions; and
varying an arrangement of the plurality of non-overlapping display regions in accordance with an amount of the display uncovered by the cover element.

19. The method of displaying an image on a display of a digital image processing apparatus of claim 18, further comprising:
detecting an orientation of the cover element;
outputting an orientation signal indicative of the orientation to the image controlling unit; and
varying a display signal for controlling the display relative to the orientation signal.

20. The method of displaying an image on a display of a digital image processing apparatus of claim 18, further comprising:
providing a first aspect ratio for a first aspect display region; and
providing a second aspect ratio for a second aspect display region adjacent the first display region, wherein the a second aspect ratio is different from the first aspect ratio, and wherein one of the first and second aspect display regions is selectively exposed by the cover element.
